(19) United States
(12) Patent Application Publication
(10) Pub. No.: US 2013/0336438 A1
(43) Pub. Date: Dec. 19, 2013

(54) SECURING DEVICE FOR A CONTROL ROD IN A NUCLEAR PLANT

(71) Applicant: Areva Gmbh, Erlangen (DE)

(72) Inventors: BENEDIKTUS WINTERMANN, BUCKENHOF (DE); ALFRED GERSTENHOEFER, NUERNBERG (DE); PATRICK KOEHLER, NUERNBERG (DE)

(21) Appl. No.: 13/939,654

(22) Filed: Jul. 11, 2013

Related U.S. Application Data
(63) Continuation of application No. PCT/EP2012/000074, filed on Jan. 10, 2012.

(30) Foreign Application Priority Data
Jan. 11, 2011 (DE) 10 2011 008 202.6

(51) Int. Cl. G21C 7/12; G21C 13/036

(52) U.S. Cl. CPC G21C 7/12; G21C 13/036
USPC 376/219

(57) ABSTRACT

A securing device for a control rod in a nuclear plant contains a control rod drive and a drive housing, which encloses the control rod drive and which is configured to be fed through a reactor pressure wall. The aim of the securing device is to prevent, in the most reliable manner possible, the control rod from being extended in an uncontrolled manner. Furthermore, the securing device should be as inexpensive as possible and should pose the slightest obstacle possible to installation work. For this purpose, the drive housing has at least one coupling element for forming a force-locked and/or form-fit connection of the drive housing to the reactor pressure wall.

### CROSS-REFERENCE TO RELATED APPLICATION

This is a continuation application, under 35 U.S.C. §120, of copending international application No. PCT/EP2012/000074, filed Jan. 10, 2012, which designated the United States; this application also claims the priority, under 35 U.S.C. §119, of German patent application No. 10 2011 008 202.6, filed Jan. 11, 2011; the prior applications are herewith incorporated by reference in their entireties.

### BACKGROUND OF THE INVENTION

### Field of the Invention

The invention relates to a securing device for a control rod in a nuclear plant.

In a nuclear plant, for example in a nuclear power station, linearly displaceable control rods are used in order to control chain reactions of nuclear decay processes in a reactor, wherein particle radiation—in particular neutron radiation—is emitted, this control being effected by absorption of the radiation. The further such control rods, which are typically bundled in groups, are slid between the nuclear fuel assemblies, the greater are the absorbed proportions of the particle radiation that continues to drive the chain reaction, and therefore the chain reaction progresses slower accordingly, and, if the control rods are in the fully inserted position, is brought to a stop accordingly. The state and progression of the chain reaction are therefore dependent on the respective position of the linearly displaceable control rods and are determined thereby. A mechanical securing of the control rods in the desired position is therefore relevant for a reliable adjustment of the operating state. In particular, the positional securing in the control rod end position necessary for the shutdown of the reactor has to be ensured from a safety point of view.

In the case of boiling water reactors, high temperatures and pressures occur in the reactor loop, and therefore, in the event of a possible failure of the pressurized encapsulation of the mechanically/hydraulically actuated control rod drive, the control rods have to be secured against an uncontrolled withdrawal (“ejection”). In the event of an uncontrolled withdrawal of the control rods, there is the risk of an inadmissible increase in reactor power, which in the extreme case—that is to say in the event of a simultaneous failure of all further securing devices—could lead to a core meltdown. To secure the control rods against uncontrolled withdrawal, securing devices are normally installed in boiling water reactors, wherein the drive housing of the control rod drive is held for example by tie rods on an external shielding plate surrounding the reactor pressure vessel at a certain distance.

More specifically, the securing device used contain a control rod drive as a module to be secured, the control rod drive containing a cylindrically shaped drive housing, which surrounds the control rod drive and is guided from a reactor through the reactor pressure wall. The securing device further contains a shielding plate arranged locally parallel to the reactor pressure wall on the outer face of the reactor, the drive housing being guided through the shielding plate, and also an abutment, which is connected by a cylindrical collar to the drive housing and is held on the shielding plate by a plurality of tie rods.

Disadvantageously, the components necessary for a securing device of this type, in particular tie rods and abutments, are cost-intensive and impair the accessibility during installation procedures. In addition, at specific temperature ratios between the reactor pressure vessel, including the control rod drives, and the pressure vessel support, high forces may occur on the shielding plate, caused by thermal expansions of varying magnitude of the components. Should the drive housing break, the shielding plate has to take up the inertia forces and retarding forces introduced via the tie rods. The latter problem is normally overcome by designing and reinforcing the tie rods and the shielding plate for particularly high mechanical and thermal stresses and by installing additional deformation members for buffering mechanical stresses.

In an alternative securing device, the drive housing tube is connected directly to the internals of the reactor pressure vessel and is held in a stable manner thereby. However, in the device not all possible break locations of the drive housing are covered.

### SUMMARY OF THE INVENTION

The object of the invention is to specify a device, with which an uncontrolled withdrawal of the respective control rod can be prevented as reliably as possible, which is also as cost-effective as possible, and which, in particular for installation works, poses the slightest obstacle possible.

A securing device for a control rod/control rod drive in a nuclear plant will be proposed hereinafter. The securing device contains a control rod drive and a drive housing, which encloses the control rod drive and is configured to be guided through a reactor pressure wall. The drive housing contains at least one coupling element for forming a—preferably releasable—force-locked and/or form-fit connection between the drive housing and the reactor pressure wall.

The invention is based on the consideration of securing the drive housing of the control rod drive directly on the reactor pressure wall instead of guiding the drive housing, as in known solutions, merely through the reactor pressure wall from the inside of the reactor and securing it on a separate shielding plate by mechanical components, in particular by abutments and tie rods. Since the drive housing has to be guided through the reactor pressure wall in any case, for which purpose a recess is necessary in the reactor pressure wall, it is advantageous to combine the guiding through of the drive housing with a retaining function in the region of the recess. With the aid of a number of mechanical coupling elements, which are configured for form-fitting engagement in one another in a corresponding shaping in the reactor pressure wall in the region of the recess, or which are configured to form a force-locked and/or form-fit connection with corresponding regions in the reactor pressure wall in the region of the recess, a stable retaining function can be achieved, even with high mechanical stresses. Since coupling elements of this type can additionally be produced substantially monomorphically, they also behave in a consistent and calculable manner with respect to thermally induced expansions, and therefore the influential factor of the thermal load-bearing capacity remains limitable with suitable selection of material and shape of the coupling elements.

With the aid of an arrangement of this type, there is no need for a separate and external mechanical securing of the drive housing to a shielding plate and connecting mechanical components, which have to be configured in particular for thermal/mechanical stresses, and which in particular impair the accessibility to the drive housing and to the control rod drive, particularly during installation procedures.

The drive housing preferably has a substantially hollow-cylindrical shape and is shaped at defined heights so as to form a bayonet connection or a bayonet closure in each case. A bayonet connection is suitable in particular for a stable concentric connection of two components, of which the shaping with regard to a characteristic longitudinal axis corresponds substantially to the geometry of two concentric hollow cylinders, wherein, without the bayonet connection, the minimum inner radius of the outer hollow cylinder is greater than the maximum outer radius of the inner hollow cylinder. Due to a bayonet connection, the outer radius of the inner hollow cylinder and the inner radius of the outer hollow cylinder are locally enlarged, such that, in the closed state, both hollow cylinders engage in one another in a form-fitting manner and can no longer be displaced relative to one another with respect to the longitudinal axis. As is usual in the case of bayonet closures due to the construction, the cylindrical components are connected to one another via a plug-and-twist movement.

With a design of the, or each, coupling element in the form of a bayonet connection, the outer hollow cylinder corresponds to the reactor pressure wall with the recess, wherein the inner cylinder face is provided by the edge face of the reactor pressure wall, the edge face defining the recess. The inner hollow cylinder corresponds to the drive housing.

Further expedient embodiments of the securing device according to the invention concern the connection of the control rod drive to the drive housing. For complete securing of the control rod, the securing of the control rod drive with respect to the drive housing is also relevant besides the securing of the drive housing with respect to the reactor pressure wall, since an uncontrolled withdrawal can still also occur if the drive housing itself is indeed secured, but the retaining function of the control rod drive with respect to the drive housing fails and the control rod with the control rod drive detaches from the drive housing.

To secure the control rod drive in the drive housing, the control rod drive advantageously contains at least one inner coupling element for forming a force-locked and/or a form-fit connection between the control rod drive and the drive housing. This coupling element is preferably configured to form a releasable bayonet connection.

With an arrangement of this type, the way in which the control rod drive is secured with respect to the drive housing corresponds to the way in which the, or each, coupling element is secured between the drive housing and the reactor pressure wall. Due to the corresponding securing methods, a buffer effect with regard to energy can be achieved: The mechanical pulse produced in the event of ejection of a control rod from the reactor is initially transmitted directly from the control rod to the control rod drive and is then transmitted by the, or each, inner coupling element to the drive housing. Some of the energy originating from the inelastic portion of the impact is absorbed during this process. Similarly, the mechanical pulse of the drive housing is transmitted by the, or each, coupling element onto the reactor pressure wall, wherein the rest of the energy of the impact is reduced further still. Due to a suitable shaping and material selection of the coupling elements, the inelastic portion of the impact can be increased in comparison to the elastic portion of the impact, for example by forming plastically deformable components on the coupling elements in a suitable arrangement. In the case of a pulse transmission conveyed through such a coupling element, the impact energy is then absorbed increasingly, resulting in deformation of the components. A cascade-like reduction of the impact energy achieved by this buffering effect increases on the whole the reliability of the securing device compared to a system with a basic pulse and energy transmission, but requires each coupling element to be stable enough to perform the retaining function in the event of a pulse transmission. An increase of the redundancy of the securing device can therefore be achieved by an increase of the overall number of coupling elements.

In a suitable development of the securing device, the control rod drive contains a hollow-cylindrically shaped component, and the inner coupling element or a plurality of coupling elements is/are configured in the form of a bayonet connection.

In a particularly suitable variant of the securing device, the control rod drive contains a plurality of inner coupling elements, wherein at least one inner coupling element is formed in each end region with respect to the longitudinal direction of the control rod drive. Due to such a distributed arrangement of the inner coupling elements, a transmission of force between the control rod drive and the drive housing is distributed accordingly and is therefore improved on the whole. The greater the number of inner coupling elements, the higher is the achievable stability of the connection.

The inner coupling elements are preferably formed and arranged here in such a way that they are simultaneously released and connected by a common motion sequence (that is to say coupling process). In other words: The last-mentioned variant of the securing device is preferably developed to the extent that the inner coupling elements are mechanically coupled to the drive housing to form a force-locked and/or a form-fit connection of the control rod drive. The inner coupling elements can thus be activated jointly to release and to form the connection of the control rod drive to the drive housing. This is advantageous in particular for quick installation and in order to carry out maintenance measures.

In a further preferred embodiment of the securing device, the control rod drive contains a separate component, and a clamping element is provided for forming a force-locked and/or form-fit connection between the separate component and the drive housing.

The advantages achieved with the invention in particular lie in the fact that, by the securing of the control rod drive housing by internal couplings directly on the reactor pressure vessel wall, the previously disadvantageous effects of different thermal expansions are avoided, the previously cost-intensive components are omitted, the installation works are facilitated due to the larger free space, and the necessary retaining function is still performed reliably in the event of failure of the drive housing.

A form-locking connection is one that connects two elements together due to the shape of the elements themselves (e.g. ball and socket), as opposed to a force-locking connection, which locks the elements together by force external to the elements (e.g. a screw).

Other features which are considered as characteristic for the invention are set forth in the appended claims.

Although the invention is illustrated and described herein as embodied in a securing device for a control rod in a nuclear plant, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, sectional view of a securing device for a control rod in a nuclear plant according to the invention; and

FIG. 2 is an illustration of the securing device according to FIG. 1 in a reactor of the nuclear plant.

### DETAILED DESCRIPTION OF THE INVENTION

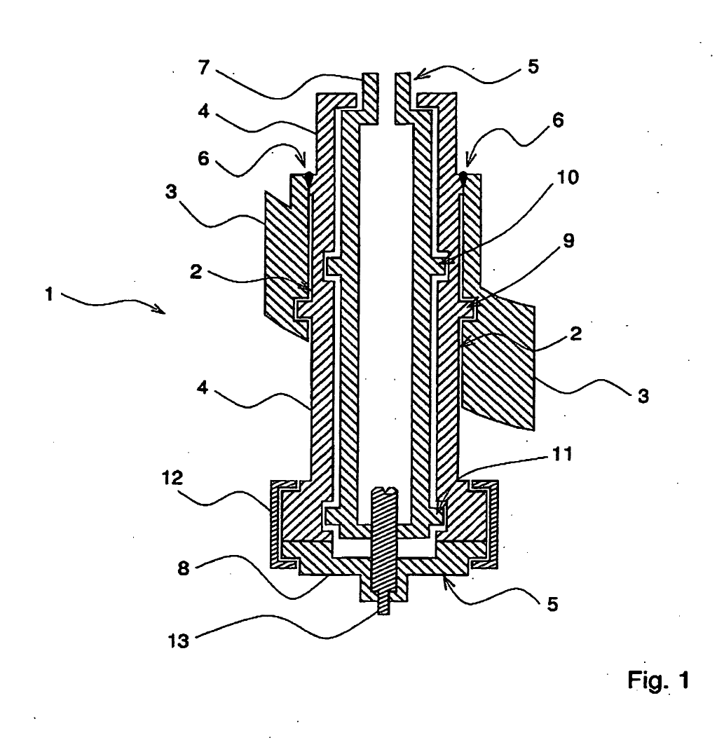

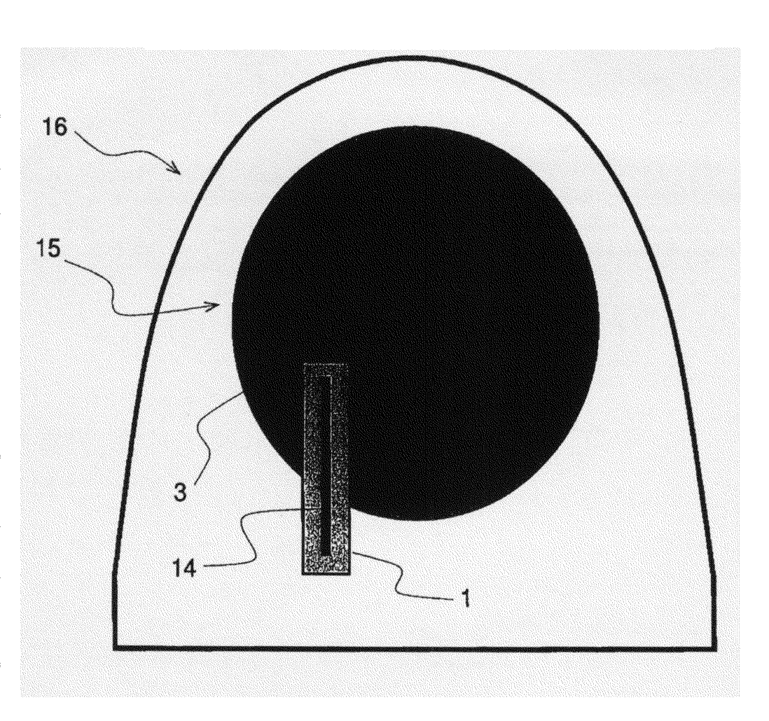

Corresponding parts in FIGS. 1 and 2 are provided with like reference signs.

Referring now to the figures of the drawing in detail and first, particularly, to FIG. 1 thereof, there is shown a schematic longitudinal sectional illustration of a securing device 1 for a control rod in a nuclear plant. The securing device 1 contains a drive housing 4 of a control rod drive 5, the drive housing 4 being guided through a recess 2 in a reactor pressure wall 3 of a reactor pressure vessel and the control rod drive 5 being connected via a connection seam 6 to the reactor pressure wall 3. The drive housing 4 has a hollow-cylindrical shape. The control rod drive 5 further contains a hollow-cylindrically shaped component 7, which is enclosed concentrically by the drive housing 4, and also a separate component 8 in the lower region of the control rod drive 5. The drive housing 4 is connected in a form-fitting manner to the reactor pressure wall 2 by a coupling element 9 configured in a form of a bayonet connection and arranged below the connection seam 6. Similarly, the hollow-cylindrically shaped component 7 of the control rod drive 5 is connected in a form-fitting manner to the drive housing 4 by an upper inner coupling element 10 and by a lower inner coupling element 11. In the installed state, the upper inner coupling element 10 is arranged below the connection seam 6 and above the outer coupling element 9. The lower inner coupling element 11 is arranged below the outer coupling element 9 in the lower end region of the hollow-cylindrically shaped component 7. The upper inner coupling element 10 and the lower inner coupling element 11 are preferably released and connected by a joint coupling process.

The separate component 7 is connected in a form-fitting manner to the drive housing 4 in the lower region of the drive housing 4 by a clamping element 12 referred to as a self-grip clamp. A drive shaft 13 of the control rod drive 5 is also visible.

FIG. 2 shows a schematic illustration of the securing device 1 according to FIG. 1 with a control rod 14 in a reactor 15 of a nuclear plant 16. The reactor 15 is enclosed by the reactor pressure wall 3.

1. A securing device for a control rod in a nuclear plant, the securing device comprising:
a control rod drive; and
a drive housing enclosing said control rod drive and configured to be guided through a reactor pressure wall, said drive housing having at least one coupling element for forming at least one of a force-locked connection or a form-fit connection between said drive housing and the reactor pressure wall.

2. The securing device according to claim 1, wherein said drive housing has a substantially hollow-cylindrical shape, and said coupling element is configured in a form of a bayonet connection.

3. The securing device according to claim 1, wherein said control rod drive contains at least one inner coupling element for forming at least one of a force-locked connection or a form-fit connection between said control rod drive and said drive housing.

4. The securing device according to claim 3, wherein said control rod drive contains a hollow-cylindrically shaped component, and at least one an inner coupling element configured in a form of a bayonet connection.

5. The securing device according to claim 3, wherein said inner coupling element of said control rod drive is one of a plurality of inner coupling elements, wherein at least one of said inner coupling elements is formed in each end region with respect to a longitudinal direction of said control rod drive.

6. The securing device according to claimed in claim 5, wherein said inner coupling elements are mechanically coupled to form at least one of a force-locked connection or a form-fit connection between said control rod drive and said drive housing.

7. The securing device according to claim 1, wherein said control rod drive contains a separate component and a clamping element for forming a force-locked connection and a form-fit connection between said separate component and said drive housing.
